(19) United States
(12) Patent Application Publication
(10) Pub. No.: US 2022/0104510 A1
(43) Pub. Date: Apr. 7, 2022

(54) METHOD FOR SUPPRESSING COLORATION OF FRYING OIL AND FAT COMPOSITION, METHOD FOR MANUFACTURING FRYING OIL AND FAT COMPOSITION, AND COLORATION-SUPPRESSING AGENT

(71) Applicant: J-OIL MILLS, Inc., Tokyo (JP)

(72) Inventors: Masayoshi SAKAINO, Tokyo (JP); Naruto MAKITA, Tokyo (JP); Hisashi ARAI, Tokyo (JP); Yousuke SAWARAGI, Tokyo (JP); Shun MATSUZAWA, Tokyo (JP); Takashi SANO, Tokyo (JP)

(21) Appl. No.: 17/427,777

(22) PCT Filed: Feb. 4, 2020
(86) PCT No.: PCT/JP2020/004033

§ 371 Date: Aug. 2, 2021

(30) Foreign Application Priority Data
Feb. 13, 2019 (JP) 2019-023605

(51) Int. Cl. A23D 9/04; A23L 5/49; A23L 5/41

(52) U.S. Cl. CPC A23D 9/04; A23V 2002/00; A23L 5/41; A23L 5/49

(57) ABSTRACT

There is provided a novel method for suppressing coloration of an oil and fat composition when a food ingredient is fried using the oil and fat composition. This method includes a step for adding a preparation oil to an edible oil and fat, and is such that: the preparation oil is a substance that has been subjected, in a step for refining a crude raw oil obtained from olives serving as an oilseed raw material, to (1) an optionally implemented neutralization step, (2) an optionally implemented bleaching step, and (3) an optionally implemented deodorization step in the stated order, without a degumming step having been implemented, where at least one of the (2) bleaching step and the (3) deodorization step is implemented; and an absorbance difference of the preparation oil is 0.05 or more, the absorbance difference being obtained by subtracting the absorbance at a wavelength of 750 nm from the absorbance at a wavelength of 660 nm, with isooctane used as a control.

### TECHNICAL FIELD

The present invention relates to a method for suppressing coloration of an oil and fat composition when a food ingredient is fried using the oil and fat composition.

### BACKGROUND ART

When a food ingredient is fried using an edible oil and fat such as rapeseed oil or soybean oil, the edible oil and fat is discolored due to a heating operation or the effects of oxygen or moisture contained in the food ingredient or the atmosphere. The quality of fried articles will worsen as the coloration of the edible oil and fat advances, therefore making it impossible to use the edible oil and fat over an extended period of time.

As prior art for suppressing coloration caused by heating of an edible oil and fat when a fried food is cooked using the edible oil and fat, Patent Document 1 discloses a method in which a pressed oil and/or extracted oil, a degummed oil, or another phosphorus-deriving component is added to a refined edible oil and fat to form a fried-food oil and fat composition, whereby the heating resistance of the fried-food oil and fat composition is improved. The fried-food oil and fat composition makes it possible to improve heating stability and, in particular, to suppress coloration and odor that are caused by heating.

### RELATED ART DOCUMENTS

### Patent Documents

[Patent Document 1] Japanese Laid-Open Patent Application No. 2009-050234

### DISCLOSURE OF THE INVENTION

### Problems the Invention is Intended to Solve

Suppressing heating-induced coloration of an oil and fat composition according to the method described above is effective, but there is still room for improvement as pertains to suppressing coloration of frying oil and fat compositions, and furthermore, Patent Document 1 neither indicates nor suggests that, even if no phosphorus-derived component is included, a preparation oil that has been prepared under specific conditions exhibits an effect for suppressing coloration.

It is accordingly an object of the present invention to provide a novel method for suppressing coloration of an oil and fat composition when a food ingredient is fried using the oil and fat composition.

### Means for Solving the Aforementioned Problems

As a result of thorough research, the inventors discovered that adding, to an edible oil and fat, a preparation oil obtained by configuring a step for refining a crude raw oil obtained from olives so as to meet specific conditions makes it possible solve the aforementioned problem.

Specifically, according to a first aspect, the present invention is a method for suppressing coloration of a frying oil and fat composition that contains an edible oil and fat,

the method being characterized by including a step for adding a preparation oil to the edible oil and fat,

the method also being characterized in that:

the preparation oil is a substance that has been subjected, in a step for refining a crude raw oil obtained from olives serving as an oilseed raw material, to

(1) an optionally implemented neutralization step,

(2) an optionally implemented bleaching step, and

(3) an optionally implemented deodorization step

in the stated order, without a degumming step having been implemented,

where at least one of the (2) bleaching step and the (3) deodorization step is implemented; and

an absorbance difference of the preparation oil is 0.05 or more, the absorbance difference being obtained by subtracting the absorbance at a wavelength of 750 nm from the absorbance at a wavelength of 660 nm, with isooctane used as a control.

In the present invention, it is preferable not to implement the (1) neutralization step.

In the present invention, the (2) bleaching step preferably involves using clay in an amount of more than 0 mass % and less than 0.25 mass % relative to the crude raw oil after the (1) step, and furthermore may be performed at a temperature of 70° C. or more and 120° C. or less for five minutes or more and 80 minutes or less, or may not be implemented.

In the present invention, the absorbance difference of the preparation oil is preferably 0.08 or more.

In the present invention, the preparation oil is preferably added so that the preparation oil content of the oil and fat composition be 0.05 mass % or more and 20 mass % or less.

In the present invention, the edible oil and fat preferably includes at least one from among rapeseed oil, soybean oil, and a palm-based oil and fat.

In addition, according to a second aspect, the present invention is a method for manufacturing a frying oil and fat composition that contains an edible oil and fat,

the method being characterized by including a step for adding a preparation oil to the edible oil and fat,

the method also being characterized in that:

the preparation oil is a substance that has been subjected, in a step for refining a crude raw oil obtained from olives serving as an oilseed raw material, to

(1) an optionally implemented neutralization step,

(2) an optionally implemented bleaching step, and

(3) an optionally implemented deodorization step

in the stated order, without a degumming step having been implemented,

where at least one of the (2) bleaching step and the (3) deodorization step is implemented; and

an absorbance difference of the preparation oil is 0.05 or more, the absorbance difference being obtained by subtracting the absorbance at a wavelength of 750 nm from the absorbance at a wavelength of 660 nm, with isooctane used as a control.

Furthermore, according to a third aspect, the present invention is an agent for suppressing coloration of a frying oil and fat composition that contains an edible oil and fat,

the coloration-suppressing agent being characterized by including a preparation oil,

the coloration-suppressing agent also being characterized in that:

the preparation oil is a substance that has been subjected, in a step for refining a crude raw oil obtained from olives serving as an oilseed raw material, to

(1) an optionally implemented neutralization step,

(2) an optionally implemented bleaching step, and

(3) an optionally implemented deodorization step

in the stated order, without a degumming step having been implemented,

where at least one of the (2) bleaching step and the (3) deodorization step is implemented; and

an absorbance difference of the preparation oil is 0.05 or more, the absorbance difference being obtained by subtracting the absorbance at a wavelength of 750 nm from the absorbance at a wavelength of 660 nm, with isooctane used as a control.

In the present invention, the phosphorus fraction of the preparation oil is preferably 0.02 mass ppm or more and 2 mass ppm or less.

In the present invention, the preparation oil is preferably included in the coloration-suppressing agent in an amount of 1 mass % or more and 100 mass % or less.

The coloration-suppressing agent of the present application specifies an invention of a product through a manufacturing method, but as described below, there are circumstances that make it impossible or substantially impractical to directly specify the coloration-suppressing agent according to the structure or characteristics thereof.

### Impossible or Impractical Circumstances

The effect of the present invention described below is obtained by selectively implementing neutralization/bleaching/deodorization steps on a crude raw oil obtained from olives serving as an oilseed raw material to produce a preparation oil that has a prescribed absorbance difference. More specifically, it is considered that, through selective implementation of these steps, components for suppressing coloration remain or are produced and exhibit the aforementioned effect. However, completely comprehensively analyzing and investigating which chemical substances contribute to the effect of the invention, among the many components included in crude raw oils, would require an unrealistic number of experiments, etc., depending on, inter alia, the treatment conditions in each of the steps. Specifically, conducting such an investigation is impossible, or is substantially impractical due to requiring considerably excessive financial expenses and time.

### Effect of the Invention

According to the method for suppressing coloration of a frying oil and fat composition, the method for manufacturing a frying oil and fat composition, and the coloration-suppressing agent of the present invention, coloration of the frying oil and fat composition is suppressed to a greater extent over coloration of an oil and fat composition to which no preparation oil was added, even if, e.g., the oil and fat composition is used in frying food ingredients over an extended period of time such as 20 to 30 hours. This suppression of coloration contributes greatly to extending the usage time of the oil and fat composition.

### BEST MODE FOR CARRYING OUT THE INVENTION

A method for manufacturing a frying oil and fat composition according to an embodiment of the present invention is described below. A method for suppressing coloration of the frying oil and fat composition and a coloration-suppressing agent according to the present invention are realized through the method for manufacturing a frying oil and fat composition in the present embodiment, and therefore are additionally described below.

The method for manufacturing a frying oil and fat composition of the present invention includes a step for adding a preparation oil to an edible oil and fat.

The edible oil and fat serves as a base oil for the oil and fat composition, and is generally a refined oil. Examples of the edible oil and fat include: rapeseed oil, soybean oil, palm-based oils and fats, palm kernel oil, corn oil, sunflower oil, olive oil, cottonseed oil, safflower oil, linseed oil, sesame oil, rice bran oil, peanut oil, coconut oil, and other vegetable oils and fats; pig lard, beef tallow, chicken fat, butterfat, and other animal oils and fats; medium-chain fatty acid triglycerides; and processed oils and fats obtained through fractionation, hydrogenation, transesterification, etc., of the aforementioned oils and fats. One of these oils and fats may be used alone, or a mixed oil in which two or more are combined may be used as the edible oil and fat. The edible oil and fat preferably includes at least one from among rapeseed oil, soybean oil, and palm-based oils and fats. “Palm-based oils and fats” refers to palm oil and processed oils and fats derived from palm oil. The total content amount for rapeseed oil, soybean oil, and palm-based oils and fats in the edible oil and fat is preferably 60 mass % or more and 100 mass % or less, more preferably 75 mass % or more and 100 mass % or less, even more preferably 90 mass % or more and 100 mass % or less, and particularly preferably 100 mass %.

The melting point of the edible oil and fat is preferably 10° C. or less, and more preferably 0° C. or less. In the present specification, “melting point” refers to the rising melting point. The rising melting point can be measured in conformance with section 3.2.2.2-2013 in “The Japan Oil Chemists' Society (JOCS) Standard Methods for the Analysis of Fats, Oils, and Related Materials.”

The edible oil and fat content relative to the frying oil and fat composition should be 80 mass % or more, and is preferably 88 mass % or more, more preferably 90 mass % or more, and particularly preferably 93 mass % or more. There is no particular upper limit of the edible oil and fat content, but the total of the edible oil and fat and the preparation oil is 100 mass % or less.

A crude raw oil obtained from olives serving as an oilseed raw material is used in the preparation oil. In the present invention, “crude raw oil obtained from olives serving as an oilseed raw material” refers to an oil obtained by pressing olive fruits through use of mechanical means or other physical means (e.g., compression, centrifugation, or filtration), or to an oil extracted by using an organic solvent on olive fruits. Examples of the crude raw oil include extra virgin olive oil, virgin olive oil, ordinary virgin olive oil, lampante virgin olive oil, and crude olive pomace oil. Among these olive oils, extra virgin olive oil does not include flavor faults derived from olive oil, and therefore is preferred due to not adversely affecting the flavor of the frying oil and fat composition into which the olive oil is incorporated.

The preparation oil is a substance that has been subjected, in a step for refining the crude raw oil obtained from olives described above, to (1) an optionally implemented neutralization step, (2) an optionally implemented bleaching step, and (3) an optionally implemented deodorization step in the stated order (where at least one of (2) and (3) is implemented), without a degumming step having been implemented.

In the “degumming step” mentioned above, a gum substance contained in an oil fraction is hydrated and removed, the gum substance having a phospholipid as a main component; typically, such a step is normally performed in a step for refining an edible oil and fat, but as indicated above, no degumming step is implemented in the present invention.

In the (1) neutralization step, free fatty acids contained in the oil fraction are removed as a soap fraction by treatment using an aqueous solution of an alkali such as sodium carbonate or caustic soda. There are no particular limitations as to the conditions in the neutralization step; general-purpose conditions can be used. The neutralization treatment may involve a physical refining technique in which no alkali is used; the physical refining techniques include steam distillation techniques and molecular distillation techniques. The oil obtained through the neutralization step is a neutralized oil. In the present invention, the neutralization step is optional, but is preferably not implemented.

In the (2) bleaching step, pigments included in the oil fraction are adsorbed onto activated clay, activated carbon, etc., and thereby removed. The bleaching step is generally performed under anhydrous conditions, but may also be performed in the presence of water. The conditions for the bleaching step include, for example, using clay, and preferably activated clay, the amount of clay used being more than 0 mass % and 5 mass % or less relative to the crude raw oil or the neutralized oil, the bleaching temperature being 60° C. or more and 120° C. or less, and the bleaching time being five minutes or more and 120 minutes or less. The clay, etc., to which the pigment has adhered in the bleaching step is removed by filtration, etc. The oil obtained through the bleaching step is a bleached oil.

In the present invention, the amount of clay used is preferably more than 0 mass % and less than 0.25 mass % relative to the crude raw oil or the neutralized oil, and more preferably 0.01 mass % or more and 0.18 mass % or less. The bleaching temperature is preferably 70° C. or more and 120° C. or less, and more preferably 70° C. or more and 110° C. or less. The bleaching time is preferably five minutes or more and 80 minutes or less, and more preferably five minutes or more and 60 minutes or less. When a mild bleaching step is implemented under such conditions, or when the bleaching step is not implemented, a preparation oil having an absorbance difference within the range stipulated in the present invention is easily obtained.

In the (3) deodorization step, odorous components contained in the oil fraction are removed by steam distillation under reduced pressure. The deodorization step can be performed on, e.g., the crude raw oil, the neutralized oil, or the bleached oil under conditions such that the amount of steam used is 0.1 mass % or more and 10 mass % or less, the deodorization temperature is 180° C. or more and 300° C. or less, the reduced pressure is 150 Pa or more and 1000 Pa or less, and the deodorization time is ten minutes or more and 240 minutes or less. The amount of steam used is preferably 0.3 mass % or more and 8 mass % or less, and more preferably 0.3 mass % or more and 5 mass % or less, relative to the amount of the crude raw oil, the neutralized oil, or the bleached oil. The deodorization temperature is preferably 200° C. or more and 270° C. or less, and more preferably 200° C. or more and 250° C. or less. The reduced pressure depends on the temperature, but is preferably 200 Pa or more and 800 Pa or less. The deodorization time depends on the deodorization temperature and the reduced pressure, but is preferably 20 minutes or more and 240 minutes or less, and more preferably 20 minutes or more and 180 minutes or less.

In the present invention, it is preferable to implement the deodorization step without implementing the bleaching step, but it is permissible to implement both the bleaching step and the deodorization step. It is also permissible to implement the bleaching step and not implement the deodorization step.

In the present invention, an absorbance difference of the preparation oil is 0.05 or more, preferably 0.08 or more, and more preferably 0.15 or more, the absorbance difference being obtained by subtracting the absorbance at a wavelength of 750 nm from the absorbance at a wavelength of 660 nm, with isooctane used as a control. Due to the absorbance difference being 0.05 or more, it is possible to achieve a high effect for suppressing coloration and to minimize the amount of preparation oil added to the edible oil and fat. The upper limit of the absorbance difference is 2.0 or less, preferably 1.5 or less, and more preferably 1.0 or less.

“Absorbance difference of the preparation oil” refers to the absorbance difference after the deodorization step in cases where the deodorization step is implemented without implementing the bleaching step, to the absorbance difference after the bleaching step in cases where the bleaching step is implemented and the deodorization step is not implemented, and to the absorbance difference after the deodorization step in cases where both the bleaching step and the deodorization step are implemented.

After the deodorization step (or the bleaching step in cases where no deodorization step is implemented), a coloration-suppressing agent that contains the preparation oil described above is added to the edible oil and fat.

A phosphorus fraction of the preparation oil preferably constitutes 0.02 mass ppm or more and 2 mass ppm or less, more preferably 0.08 mass ppm or more and 1.5 mass ppm or less, even more preferably 0.1 mass ppm or more and 1 mass ppm or less, and yet even more preferably 0.1 mass ppm or more and 0.8 mass ppm or less.

The coloration-suppressing agent of the present invention preferably contains the preparation oil in an amount of 1 mass % or more and 100 mass % or less, more preferably 10 mass % or more and 100 mass % or less, and even more preferably 20 mass % or more and 100 mass % or less. The coloration-suppressing agent may, for example, be diluted by the edible oil and fat described above (i.e., the base oil of the oil and fat composition), and may contain an oxidation inhibitor, a defoamer, an emulsifier, a flavoring material, a biologically active substance, or other such ingredients, as appropriate.

The amount of the coloration-suppressing agent added to the frying oil and fat composition is configured so that the preparation oil contained in the oil and fat composition preferably constitutes 0.05 mass % or more and 20 mass % or less, and more preferably 1 mass % or more and 15 mass % or less.

A general-purpose auxiliary agent to be added to the edible oil and fat can be added to the frying oil and fat composition, provided that the auxiliary agent does not hinder the effect of the present invention. Examples of such an auxiliary agent include: silicone, tocopherol, and other antioxidants; flavoring materials; colorants; and emulsifiers. The frying oil and fat composition of the present invention preferably contains silicone.

The frying oil and fat composition can be used in frying at a temperature of, e.g., 140° C. or more and 230° C. or less in accordance with the food ingredients and the preparation method. Examples of fried food products include: kara-age; croquettes, fried cutlets, and other breaded fried food products; tempura; non-breaded deep-fried vegetables and seafood; fritters; fried confectionery or fried bread; fried noodles; and deep-fried tofu slices. It is preferable to use kara-age and breaded fried food products.

The effect for suppressing coloration achieved by the present invention can be evaluated using, e.g., the following method.

1. Measurement of Color Tone

The color tone of an oil and fat composition (referred to as a “test oil” below), or a base oil (referred to as a “control oil” below), that has been charged into a Lovibond cell is measured at room temperature by using a Lovibond automated colorimeter in conformance with The American Oil Chemists' Society (AOCS) Cc13j-97. The color tone (Y+10R) is derived from the Y value and the R value of the resultant color.

2. Computation of Coloration Suppression Ratio

The coloration suppression ratio of the test oil, for which the color tone of the control oil was used as a reference, is calculated using the following formula.

$$Discoloration suppression ratio ( \% ) = \{ 1 - \frac{\begin{matrix}Color tone ( Y + 10 R ) \\ of test oil after frying test\end{matrix}}{\begin{matrix}Color tone ( Y + 10 R ) \\ of control oil after frying test\end{matrix}} \} \times 100 \qquad [ Formula 1 ]$$

According to the method described above, neutralization/bleaching/deodorization steps are selectively implemented on a crude raw oil obtained from olives, without implementing a degumming step, to prepare a preparation oil, thereby making it possible to artificially manufacture a preparation oil in which an absorbance difference of the preparation oil is 0.05 or more, the absorbance difference being obtained by subtracting the absorbance at a wavelength of 750 nm from the absorbance at a wavelength of 660 nm, with isooctane used as a control. Coloration during frying is thereby suppressed by an oil and fat composition containing the preparation oil to a greater extent than with prior-art oil and fat compositions that do not contain the preparation oil. Thus, it is possible to improve the appearance of a fried article cooked using the oil and fat composition, and to use the oil and fat composition for a longer period of time.

### EXAMPLES

The present invention is described in greater detail below by indicating examples of the present invention. However, the present invention is in no way limited to the examples described below.

The following raw ingredients were used in experiments.

Extra virgin olive oil: AJINOMOTO olive oil extra virgin, produced by J-Oil Mills, Inc.; lots 1 to 3

Refined rapeseed oil: J canola oil, produced by J-Oil Mills, Inc. (melting point: 0° C. or less)

Refined soybean oil: J soybean white squeezed oil, produced by J-Oil Mills, Inc. (melting point: 0° C. or less)

Refined palm olein: Fry oil J (iodine value: 67), produced by J-Oil Mills, Inc. (melting point: 0° C. or less)

### (1) Experiment 1

(Preparation of Preparation Oil 1)

Extra virgin olive oil (lot 1) was readied as a crude raw oil and was subjected to a deodorization treatment for 45 minutes at a temperature of 250° C. and a reduced pressure of 400 Pa, with the amount of steam used in the deodorization treatment being 2 mass %, to obtain a preparation oil 1.

(Measurement of Absorbance Difference)

The absorbance difference of the resultant preparation oil 1 was measured using the method described below, the absorbance difference being obtained by subtracting the absorbance at a wavelength of 750 nm from the absorbance at a wavelength of 660 nm, with isooctane used as a control. First, isooctane (reagent for spectroscopic analysis, produced by Wako Pure Chemical Industries, Ltd.) was charged into quartz cells (1 cm) for control and for measurement, and an ultraviolet-visible spectrophotometer (trade name “Shimadzu UV-2450,” produced by Shimadzu Corp.) was used to correct a baseline within the range of 600 to 750 nm. The preparation oil 1 was then charged into a quartz cell for measurement, the absorbance of the preparation oil 1 was measured, and the absorbance at 660 nm, in a situation where the absorbance at 750 nm was set as zero, was derived to arrive at the absorbance difference.

(Measurement of Phosphorus Fraction)

The resultant preparation oil 1 was diluted with xylene, and an ICP emission spectroscopic analyzer (produced by Hitachi High-Tech Science Corp.) was used to measure the concentration of a phosphorus fraction. A CONOSTAN (registered trademark) Oil Analysis Standard (produced by SCP Science) was used for quantification of the preparation oil 1.

### Example 1-1: Preparation of Frying Oil and Fat Composition

A refined rapeseed oil was readied as an edible oil and fat (base oil), and the preparation oil 1 was added to the refined rapeseed oil so as to reach an amount of 2.7 mass %, whereby a frying oil and fat composition (test oil of example 1-1) was prepared.

A refined rapeseed oil that was a base oil was readied as a control oil for comparative example 1-1 contrasting with example 1-1.

A frying oil and fat composition (test oil of comparative example 1-2; test oil to which crude raw oil was added) was prepared in the same manner as that in example 1-1, except that no deodorization treatment was performed on the extra virgin olive oil.

(Frying Test)

Frying tests were performed on the test oils and control oil in example 1-1 and comparative examples 1-1 and 1-2.

The following processed food ingredients were readied as materials to be fried in the frying tests.

Kara-age: trade name “Wakadori kara-age GX388” (produced by Ajinomoto Frozen Foods Co., Inc.; stored at −20° C.); potato croquettes: trade name “New potato kurokke 60 (GC080)” (about 60 g per croquette; produced by Ajinomoto Frozen Foods Co., Inc.; stored at −20° C.)

3.4 kg of the test oil or the control oil was introduced into an electric fryer (trade name “FM-3HR”; produced by Mach Kiki KK) and was heated to a frying temperature of 180° C., after which the kara-age or the potato croquettes were introduced frozen into the electric fryer under the conditions indicated below. The foods were fried for ten hours per day, totaling 30 hours over the course of three days. In this instance, each of the test oil and the control oil was sampled after 20 hours and after 30 hours.

Kara-age: frying weight: 400 g per instance; frying time: five minutes per instance; number of instances of frying: five instances per day (first to third days)

Potato croquettes: frying quantity: five croquettes per instance; frying time: five minutes per instance; number of instances of frying: two instances per day (first day only)

(Measurement of Color Tone)

The color tone of each of the sampled test oils and control oil in example 1-1 and comparative examples 1-1 and 1-2 was measured. Specifically, a Lovibond automated colorimeter (Lovibond (registered trademark) PFXi-880, produced by The Tintometer Ltd.) was used in conformance with The American Oil Chemists' Society (AOCS) Cc13j-97 to measure the color of the test oils and control oil at room temperature, the test oils and control oil having been charged into Lovibond cells (W600/OG/1 inch). The color tone (Y+10R) was derived from the Y value and the R value of the resultant color.

(Computation of Coloration Suppression Ratio)

The coloration suppression ratio of the test oils in example 1-1 and comparative example 1-2, for which the color tone of the control oil in comparative example 1-1 was used as a reference, was calculated using the following formula.

$$Discoloration suppression ratio ( \% ) = \{ 1 - \frac{\begin{matrix}Color tone ( Y + 10 R ) \\ of test oil after frying test\end{matrix}}{\begin{matrix}Color tone ( Y + 10 R ) \\ of control oil after frying test\end{matrix}} \} \times 100 \qquad [ Formula 2 ]$$

The results obtained in relation to example 1-1 and comparative examples 1-1 and 1-2 are shown in table 1. The concentration of the phosphorus fraction in the oil and fat composition is a value calculated from the concentration of the phosphorus fraction in the preparation oil and the preparation oil content of the oil and fat composition.

TABLE 1

| | | Preparation oil | | | | | |
|---|---|---|---|---|---|---|---|
| | | | | | | | Phosphorus |
| | Edible oil | | | | | | fraction of |
| | and fat | | | | | Absorbance | preparation oil |
| | (base oil) | | Neutralization | Bleaching | Deodorization | difference | (mass ppm) |
| Comparative | Refined | — | | | | | |
| example 1-1 | rapeseed | | | | | | |
| Example 1-1 | oil | Preparation | x | x | ∘ | 0.178 | 0.2 |
| | | oil 1 | | | | | |
| Comparative | | Crude raw | x | x | x | 0.196 | 0.2 |
| example 2-2 | | oil | | | | | |

Oil and fat composition

| | |
|---|---|
| After 20 hours | After 30 hours |

| | | Phosphorus fraction of oil | | Coloration | | Coloration |
|---|---|---|---|---|---|---|
| | Preparation oil | and fat composition | Color | suppression ratio | Color | suppression ratio |
| | content (mass %) | (mass ppm) | tone | (%) | tone | (%) |
| Comparative | — | | 35 | — | 78 | — |
| example 1-1 | | | | | | |
| Example 1-1 | 2.7 | 0.0054 | 32 | 8.6 | 61 | 21.8 |
| Comparative | 2.7 | 0.0054 | 39 | −11.4 | 79 | −1.3 |
| example 2-2 | | | | | | |

As shown in table 1, in example 1-1, in which was added the preparation oil 1 that was subjected to the deodorization step and that had an absorbance difference compliant with the present invention, the color tone after each of 20 hours and 30 hours was minimized to a greater extent than in comparative example 1-1, which did not contain a preparation oil, and comparative example 1-2, in which was added the extra virgin olive oil (crude raw oil) that was not subjected to any neutralization/bleaching/deodorization step. Specifically, coloration of the oil and fat composition during frying was suppressed. The phosphorus fraction in the oil and fat composition in example 1-1 was very low, at 0.0054 mass ppm, and it was understood that the coloration suppression effect in example 1-1 was not caused by a component derived from phosphorus.

### (2) Experiment 2

In example 2-1, a preparation oil 2 and a frying oil and fat composition were prepared in the same manner as those in example 1-1, except that the preparation oil content of the frying oil and fat composition was 3 mass %; the same measurements as in example 1-1 were performed. In example 2-2, a preparation oil 3 and a frying oil and fat composition were prepared and measured in the same manner as those in example 2-1, except that the extra virgin olive oil was subjected to a bleaching treatment and was not subjected to a deodorization treatment. The bleaching treatment was performed at a temperature of 80° C. for 30 minutes, with the amount of activated clay (V2R, produced by Mizusawa Industrial Chemicals Ltd.) used being 0.1 mass % relative to the extra virgin olive oil. In example 2-3, a preparation oil 4 and a frying oil and fat composition were prepared and measured in the same manner as those in example 2-1, except that the extra virgin olive oil was subjected to a bleaching treatment and then to a deodorization treatment. The bleaching treatment was performed under the same conditions as in example 2-2, and the deodorization treatment was performed under the same conditions as in example 2-1. In experiment 2, lot 2 of the extra virgin olive oil was used.

A refined rapeseed oil that was a base oil was readied as a control oil for comparative example 2-1 contrasting with examples 2-1 to 2-3.

A preparation oil 5 and a frying oil and fat composition were prepared and measured, as comparative example 2-2 contrasting with example 2-3, in the same manner as those in example 2-3, except that the amount of activated clay used was 0.25 mass %.

The results obtained in relation to examples 2-1 to 2-3 and comparative examples 2-1 and 2-2 are shown in table 2.

TABLE 2

| | | Preparation oil | | | | | |
|---|---|---|---|---|---|---|---|
| | | | | | | | Phosphorus |
| | Edible oil | | | | | | fraction of |
| | and fat | | | | | Absorbance | preparation oil |
| | (base oil) | | Neutralization | Bleaching | Deodorization | difference | (mass ppm) |
| Comparative | Refined | — | | | | | |
| example 2-1 | rapeseed | | | | | | |
| Example 2-1 | oil | Preparation | x | x | ∘ | 0.165 | 0.5 |
| | | oil 2 | | | | | |
| Example 2-2 | | Preparation | x | ∘ | x | 0.142 | 0.4 |
| | | oil 3 | | | | | |
| Example 2-3 | | Preparation | x | ∘ | ∘ | 0.088 | 0.4 |
| | | oil 4 | | | | | |
| Comparative | | Preparation | x | ∘ | ∘ | 0.035 | 0.4 |
| example 2-2 | | oil 5 | | | | | |

Oil and fat composition

| | |
|---|---|
| After 20 hours | After 30 hours |

| | | Phosphorus fraction of oil | | Coloration | | Coloration |
|---|---|---|---|---|---|---|
| | Preparation oil | and fat composition | Color | suppression ratio | Color | suppression ratio |
| | content (mass %) | (mass ppm) | tone | (%) | tone | (%) |
| Comparative | — | | 35 | — | 70 | — |
| example 2-1 | | | | | | |
| Example 2-1 | 3 | 0.015 | 34 | 2.9 | 65 | 7.1 |
| Example 2-2 | 3 | 0.012 | 35 | 0 | 67 | 4.3 |
| Example 2-3 | 3 | 0.012 | 34 | 2.9 | 67 | 4.3 |
| Comparative | 3 | 0.012 | 36 | −2.9 | 70 | 0 |
| example 2-2 | | | | | | |

As shown in table 2, in example 2-1, in which was added the preparation oil 2 that was subjected to the deodorization step and that had an absorbance difference compliant with the present invention, example 2-2, in which was added the preparation oil 3 that was subjected to the bleaching step and that had an absorbance difference compliant with the present invention, and example 2-3, in which was added the preparation oil 4 that was subjected to the deodorization step and the bleaching step and that had an absorbance difference compliant with the present invention, it was understood that coloration of the oil and fat composition during frying was suppressed to a greater extent than in comparative example 2-1, which did not contain a preparation oil. In addition, from comparative example 2-2, it was understood that the preparation oil 5, which did not have an absorbance difference compliant with the present invention, did not suppress coloration of the oil and fat composition during frying even when the bleaching step and the deodorization step were implemented; this, in combination with results described below, made it possible to confirm the effect of the present invention at an absorbance difference of 0.088 or more and 0.244 or less. Furthermore, from a comparison of example 2-1 and example 2-2, it was understood that it is preferable to implement the deodorization step without implementing the bleaching step.

### (3) Experiment 3

In examples 3-1 to 3-4, preparation oils 6 to 9 and frying oil and fat compositions were prepared and measured in the same manner as those in example 2-1, except that the deodorization temperature was 200° C. (example 3-1), 230° C. (example 3-2), 250° C. (example 3-3), or 270° C. (example 3-4). In experiment 3, lot 3 of the extra virgin olive oil was used. Therefore, example 3-3 (preparation oil 8), in which the deodorization temperature was 250° C., involved the same conditions as example 2-1 (preparation oil 2), but the lot of extra virgin olive oil was different.

A refined rapeseed oil that was a base oil was readied as a control oil for comparative example 3-1 contrasting with examples 3-1 to 3-4.

The results obtained in relation to examples 3-1 to 3-4 and comparative example 3-1 are shown in table 3.

TABLE 3

| | | Preparation oil | | | | | |
|---|---|---|---|---|---|---|---|
| | | | | | | | Phosphorus |
| | Edible oil | | | | | | fraction of |
| | and fat | | | | | Absorbance | preparation oil |
| | (base oil) | | Neutralization | Bleaching | Deodorization | difference | (mass ppm) |
| Comparative | Refined | — | | | | | |
| example 3-1 | rapeseed | | | | | | |
| Example 3-1 | oil | Preparation | x | x | ∘ | 0.244 | 0.2 |
| | | oil 6 | | | | | |
| Example 3-2 | | Preparation | x | x | ∘ | 0.225 | 0.2 |
| | | oil 7 | | | | | |
| Example 3-3 | | Preparation | x | x | ∘ | 0.208 | 0.2 |
| | | oil 8 | | | | | |
| Example 3-4 | | Preparation | x | x | ∘ | 0.201 | 0.2 |
| | | oil 9 | | | | | |

Oil and fat composition

| | |
|---|---|
| After 20 hours | After 30 hours |

| | | Phosphorus fraction of oil | | Coloration | | Coloration |
|---|---|---|---|---|---|---|
| | Preparation oil | and fat composition | Color | suppression ratio | Color | suppression ratio |
| | content (mass %) | (mass ppm) | tone | (%) | tone | (%) |
| Comparative | — | | 37 | — | 82 | — |
| example 3-1 | | | | | | |
| Example 3-1 | 3 | 0.006 | 33 | 10.8 | 65 | 20.7 |
| Example 3-2 | 3 | 0.006 | 35 | 5.4 | 69 | 15.9 |
| Example 3-3 | 3 | 0.006 | 26 | 29.7 | 49 | 40.2 |
| Example 3-4 | 3 | 0.006 | 37 | 0 | 80 | 2.4 |

As shown in table 3, with preparation oils 6 to 9, which were subjected to the deodorization step and had an absorbance difference compliant with the present invention, it was understood that coloration of the oil and fat composition during frying was suppressed irrespective of the deodorization temperature. In experiment 3, it was possible to achieve the effect of the present invention at a deodorization temperature of 200° C. or more and 270° C. or less. In addition, from the results above, it is understood that the preferred deodorization temperature is 200° C. or more and 250° C. or less.

### (4) Experiment 4

In examples 4-1 to 4-4, frying oil and fat compositions were prepared and measured in the same manner as that in example 3-3, except that the preparation oil 8 described above was used as a preparation oil, and the preparation oil 8 content of the frying oil and fat composition was 1 mass % (example 4-1), 5 mass % (example 4-2), 8 mass % (example 4-3), or 15 mass % (example 4-4). However, in example 4-1, no measurement after 30 hours was implemented.

A refined rapeseed oil that was a base oil was readied as a control oil for comparative example 4-1 contrasting with examples 4-1 to 4-4.

The results obtained in relation to examples 4-1 to 4-4 and comparative example 4-1 are shown in table 4.

TABLE 4

| | | Preparation oil | | | | | |
|---|---|---|---|---|---|---|---|
| | | | | | | | Phosphorus |
| | Edible oil | | | | | | fractionof |
| | and fat | | Neutralization | Bleaching | Deodorization | Absorbance | preparation oil |
| | (base oil) | | step | step | step | difference | (mass ppm) |
| Comparative | Refined | — | | | | | |
| example 4-1 | rapeseed | | | | | | |
| Example 4-1 | oil | Preparation | x | x | ∘ | 0.208 | 0.2 |
| | | oil 8 | | | | | |
| Example 4-2 | | Preparation | x | x | ∘ | 0.208 | 0.2 |
| | | oil 8 | | | | | |
| Example 4-3 | | Preparation | x | x | ∘ | 0.208 | 0.2 |
| | | oil 8 | | | | | |
| Example 4-4 | | Preparation | x | x | ∘ | 0.208 | 0.2 |
| | | oil 8 | | | | | |

| | Oil and fat composition | | | | | |
|---|---|---|---|---|---|---|
| | | | After 20 hours | | After 30 hours | |
| | | Phosphorus fraction of oil | | Coloration | | Coloration |
| | Preparation oil | and fat composition | Color | suppression ratio | | suppression ratio |
| | content (mass %) | (mass ppm) | tone | (%) | Color tone | (%) |
| Comparative | — | | 39 | — | 65 | — |
| example 4-1 | | | | | | |
| Example 4-1 | 1 | 0.002 | 35 | 10.3 | Not | |
| | | | | | implemented | |
| Example 4-2 | 5 | 0.01 | 27 | 30.8 | 49 | 24.6 |
| Example 4-3 | 8 | 0.016 | 25 | 35.9 | 43 | 33.8 |
| Example 4-4 | 15 | 0.03 | 24 | 38.5 | 43 | 33.8 |

As shall be understood from table 4, the effect of the present invention is confirmed in frying oil and fat compositions that contain 1 mass % or more and 15 mass % or less of the preparation oil, and the coloration suppression effect improved commensurately with increases in the preparation oil content of the frying oil and fat composition.

### (5) Experiment 5

In example 5-1, a frying oil and fat composition was prepared and measured in the same manner as that in example 2-1, except that refined soybean oil was used as the edible oil and fat in lieu of the refined rapeseed oil, and the preparation oil 8 described above was used as the preparation oil.

A refined soybean oil that was a base oil was readied as a control oil for comparative example 5-1 contrasting with example 5-1.

In example 5-2, a frying oil and fat composition was prepared and measured in the same manner as that in example 2-1, except that refined palm olein was used as the edible oil and fat in lieu of the refined rapeseed oil.

Refined palm olein that was a base oil was readied as a control oil for comparative example 5-2 contrasting with example 5-2.

The results obtained in relation to examples 5-1 and 5-2 and comparative examples 5-1 and 5-2 are shown in table 5.

TABLE 5

| | | Preparation oil | | | | | |
|---|---|---|---|---|---|---|---|
| | | | | | | | Phosphorus |
| | Edible oil | | | | | | fraction of |
| | and fat | | | | | Absorbance | preparation oil |
| | (base oil) | | Neutralization | Bleaching | Deodorization | difference | (mass ppm) |
| Comparative | Refined | — | | | | | |
| example 5-1 | soybean oil | | | | | | |
| Example 5-1 | | Preparation | x | x | ∘ | 0.208 | 0.2 |
| | | oil 8 | | | | | |
| Comparative | Refined | — | | | | | |
| example 5-2 | palm olein | | | | | | |
| Example 5-2 | | Preparation | x | x | ∘ | 0.165 | 0.5 |
| | | oil 2 | | | | | |

| | Oil and fat composition | | | | | |
|---|---|---|---|---|---|---|
| | | | After 20 hours | | After 30 hours | |
| | | Phosphorus fraction of oil | | Coloration | | Coloration |
| | Preparation oil | and fat composition | Color | suppression ratio | Color | suppression ratio |
| | content (mass %) | (mass ppm) | tone | (%) | tone | (%) |
| Comparative | | — | 27 | — | 43 | — |
| example 5-1 | | | | | | |
| Example 5-1 | 3 | 0.006 | 24 | 11.1 | 36 | 16.3 |
| Comparative | | — | 51 | — | 79 | — |
| example 5-2 | | | | | | |
| Example 5-2 | 3 | 0.015 | 45 | 11.8 | 79 | 0 |

As shown in table 5, it was understood that, when a preparation oil that has been subjected to a deodorization step and that has an absorbance difference compliant with the present invention is added, coloration of the oil and fat composition during frying is suppressed even if the edible oil and fat used is soybean oil or palm olein. From the results pertaining to examples 3-3 and 5-1, it was understood that rapeseed oil is preferred as the edible oil and fat. In addition, from the results pertaining to examples 2-1 and 5-2, it was understood that palm olein is preferred in a heating time of about 20 hours.

1. A method for suppressing coloration of a frying oil and fat composition that contains an edible oil and fat,
the method being characterized by including a step for adding a preparation oil to the edible oil and fat,
the method also being characterized in that:
the preparation oil is a substance that has been subjected, in a step for refining a crude raw oil obtained from olives serving as an oilseed raw material, to
(1) an optionally implemented neutralization step,
(2) an optionally implemented bleaching step, and
(3) an optionally implemented deodorization step
in the stated order, without a degumming step having been implemented,
where at least one of the (2) bleaching step and the (3) deodorization step is implemented; and
an absorbance difference of the preparation oil is 0.05 or more, the absorbance difference being obtained by subtracting the absorbance at a wavelength of 750 nm from the absorbance at a wavelength of 660 nm, with isooctane used as a control.

2. The suppression method according to claim 1, wherein the (1) neutralization step is not implemented.

3. The suppression method according to claim 1, wherein the (2) bleaching step involves using clay in an amount of more than 0 mass % and less than 0.25 mass % relative to the crude raw oil after the (1) step.

4. The suppression method according to claim 3, wherein the (2) bleaching step is performed at a temperature of 70° C. or more and 120° C. or less for five minutes or more and 80 minutes or less.

5. The suppression method according to claim 1, wherein the (2) bleaching step is not implemented.

6. The suppression method according to claim 1, wherein the absorbance difference is 0.08 or more.

7. The suppression method according to claim 1, wherein the preparation oil is added so that the preparation oil content of the oil and fat composition be 0.05 mass % or more and 20 mass % or less.

8. The suppression method according to claim 1, wherein the edible oil and fat includes at least one from among rapeseed oil, soybean oil, and a palm-based oil and fat.

9. A method for manufacturing a frying oil and fat composition that contains an edible oil and fat,
the method being characterized by including a step for adding a preparation oil to the edible oil and fat,
the method also being characterized in that:
the preparation oil is a substance that has been subjected, in a step for refining a crude raw oil obtained from olives serving as an oilseed raw material, to
(1) an optionally implemented neutralization step,
(2) an optionally implemented bleaching step, and
(3) an optionally implemented deodorization step
in the stated order, without a degumming step having been implemented,
where at least one of the (2) bleaching step and the (3) deodorization step is implemented; and
an absorbance difference of the preparation oil is 0.05 or more, the absorbance difference being obtained by subtracting the absorbance at a wavelength of 750 nm from the absorbance at a wavelength of 660 nm, with isooctane used as a control.

10. An agent for suppressing coloration of a frying oil and fat composition that contains an edible oil and fat,
the coloration-suppressing agent being characterized by including a preparation oil,
the coloration-suppressing agent also being characterized in that:
the preparation oil is a substance that has been subjected, in a step for refining a crude raw oil obtained from olives serving as an oilseed raw material, to
(1) an optionally implemented neutralization step,
(2) an optionally implemented bleaching step, and
(3) an optionally implemented deodorization step
in the stated order, without a degumming step having been implemented,
where at least one of the (2) bleaching step and the (3) deodorization step is implemented; and
an absorbance difference of the preparation oil is 0.05 or more, the absorbance difference being obtained by subtracting the absorbance at a wavelength of 750 nm from the absorbance at a wavelength of 660 nm, with isooctane used as a control.

11. The coloration-suppressing agent according to claim 10, wherein the phosphorus fraction of the preparation oil is 0.02 mass ppm or more and 2 mass ppm or less.

12. The coloration-suppressing agent according to claim 10, wherein the preparation oil is included in an amount of 1 mass % or more and 100 mass % or less.

13. The suppression method according to claim 2, wherein the (2) bleaching step involves using clay in an amount of more than 0 mass % and less than 0.25 mass % relative to the crude raw oil after the (1) step.

14. The suppression method according to claim 2, wherein the (2) bleaching step is not implemented.

15. The coloration-suppressing agent according to claim 11, wherein the preparation oil is included in an amount of 1 mass % or more and 100 mass % or less.
